(19) United States
(12) Patent Application Publication
(10) Pub. No.: US 2002/0069370 A1
(43) Pub. Date: Jun. 6, 2002

(54) System and method for tracking and preventing illegal distribution of proprietary material over computer networks

(75) Inventor: David Mack, Clifton, VA (US)

Correspondence Address: GREENBERG-TRAURIG, 1750 TYSONS BOULEVARD, 12TH FLOOR, MCLEAN, VA, 22102, US

(73) Assignee: Infoseer, Inc.

(21) Appl. No.: 09/942,928

(22) Filed: Aug. 31, 2001

Related U.S. Application Data
(60) Provisional application No. 60/229,037, filed on Aug. 31, 2000.
(60) Provisional application No. 60/229,040, filed on Aug. 31, 2000.
(60) Provisional application No. 60/229,038, filed on Aug. 31, 2000.
(60) Provisional application No. 60/229,039, filed on Aug. 31, 2000.
(60) Provisional application No. 60/248,283, filed on Nov. 14, 2000.

(51) Int. Cl. G06F 11/30

(52) U.S. Cl. 713/201

(57) ABSTRACT

An intelligent router includes means for analyzing content being transferred through it, and means for identifying if the content is proprietary.

This application claims priority to U.S. Provisional Patent Application No. 60/229,037, filed Aug. 31, 2000, U.S. Provisional Patent Application No. 60/229,040, filed Aug. 31, 2000, U.S. Provisional Patent Application No. 60/229,038, filed Aug. 31, 2000, U.S. Provisional Patent Application No. 60/229,039, filed Aug. 31, 2000, U.S. Provisional Patent Application No. 60/248,283, filed Nov. 14, 2000, U.S. Provisional Patent Application No. ______, entitled SYSTEM AND METHODS FOR INCORPORATING CONTENT INTELLIGENCE INTO NETWORK SWITCHING, FIREWALL, ROUTING AND OTHER INFRASTRUCTURE EQUIPMENT, filed Aug. 23, 2001, and U.S. Provisional Patent Application No.______, entitled SYSTEM AND METHODS FOR POSITIVE IDENTIFICATION AND CORRECTION OF FILES AND FILE COMPONENTS, filed Aug. 23, 2001, which are all incorporated herein by reference.

This application is related to commonly owned U.S. patent application Ser. No.______, filed on Aug. 31, 2001, entitled SYSTEM AND METHOD FOR POSITIVE IDENTIFICATION OF ELECTRONIC FILES, commonly owned U.S. patent application Ser. No. ______, filed on Aug. 31, 2001, entitled SYSTEM AND METHOD FOR PROTECTING PROPRIETARY MATERIAL ON COMPUTER NETWORKS and commonly owned U.S. patent application Ser. No.______, filed on Aug. 31, 2001, entitled SYSTEM AND METHOD FOR CONTROLLING FILE DISTRIBUTION AND TRANSFER ON A COMPUTER, which are all incorporated by reference as if fully recited herein.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of computer software, computer networks and the Internet, and more particularly, to a system and method for tracking privately owned or copyrighted material, and preventing the illegal distribution of privately owned or copyrighted material on computer networks.

### BACKGROUND OF THE INVENTION

As one example of the problem of content privacy, the entertainment industry currently has a problem with their copyrighted material being illegally distributed on the Internet. Content is being distributed without the owners thereof receiving compensation from proprietors of software packages such as Napster, Gnutella, BearShare and others. There is currently nothing in place that would protect the entertainment industry's interest when their media is distributed on the Internet. The Secure Digital Music Initiative (SDMI) is making an attempt to address the protection of copyrights but the SDMI model has several flaws (an important one of which is the protection of legacy content) that will make it difficult to enforce copyrights. SDMI states that if a software system is not SDMI compliant, it should still be allowed to use the entertainment media. This makes all their efforts to protect their currently existing data void.

### SUMMARY OF THE INVENTION

Accordingly, the present invention is directed to a system and method for tracking and preventing illegal distribution of proprietary material over computer networks that substantially obviates one or more of the problems due to limitations and disadvantages of the related art.

An object of the present invention is to provide a robust and effective system and method to control transfers of digital information that represents proprietary content.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided an intelligent router including means for analyzing content being transferred through it, and means for identifying if the content is proprietary.

In another aspect of the present invention there is provided an intelligent switch including means for analyzing content being transferred through it; and means for identifying if the content is proprietary.

In another aspect of the present invention there is provided a method for routing data across a network router including the steps of analyzing content being transferred through it; and identifying if the content is proprietary.

In another aspect of the present invention there is provided a method for routing data across a network switch including the steps of analyzing content being transferred through it; and identifying if the content is proprietary.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows an overview of a system of the invention on a local or desktop machine;

FIG. 2 is a flow chart of the algorithm for monitoring the file system;

FIG. 3 is a flow chart of the algorithm for monitoring the socket connections;

FIG. 4 is an overview of the system in place on a network; and

FIG. 5 is a flow chart representation of an example of an algorithm employed by the invention.

### DETAILED DESCRIPTION OF THE PREFERRED EMBODIMENTS

Reference will now be made in detail to the preferred embodiments of the present invention, examples of which are illustrated in the accompanying drawings.

In one embodiment, a system and method is proposed for tracking privately owned or copyrighted material and preventing the illegal distribution of privately owned or copyrighted material over computer networks. The system includes at least two parts, both of which can reside on a local computer. The first part monitors the file system of the computer in order to track files on the local computer. (Examples of such files include, for example, entertainment media files, executable files, private health and pharmaceutical records; confidential personal documents, such as wills and financial records; images, including digital pictures and CAD drawings; trade secrets, such as recipes, formulas, and customer lists; and even confidential corporate documents, such as patent applications, video games, etc.) The second part monitors network socket connections to prevent protected entertainment media files from being illegally distributed on a computer network. This will allow the entertainment industry to explore the huge market that computer networks, such as the Internet, have, while protecting their interests in their intellectual property.

Thus, one embodiment of the present invention is designed to reside on a local computer, for example, a desktop computer in a corporate LAN or WAN. Copyrighted material is tracked once the material is on the computer, and the system prevents the distribution of that material on computer networks such as the Internet.

For the sake of consistent terminology, the following convention will be used:

A unique identifier (hereinafter, tag, InfoTag, or InfoScan identifier) is created for each file, using sophisticated digital signal processing techniques. The InfoTag, apart from accurately identifying the file, is used to control content to ensure that it moves across the network infrastructure consistent with the owner's requirements. The InfoTag is not embedded in the files or the header, thereby making it literally undetectable. In the case of music, the InfoTag may be created based on, for example, the first 30 seconds of the song. The InfoTag may also contain such information as IP address of the source of the file, spectral information about the file, owner of the file, owner-defined rules associated with the file, title of work, etc.

InfoMart is an information storage system, normally in the form of a database. It maintains all the identifiers (tags) and rules associated with the protected files. This data can be used for other value-added marketing and strategic planning purposes. Using the DNS model, the InfoMart database can be propagated to ISP's on a routine basis, updating their local versions of the InfoMart database.

InfoWatch collects information about content files available on the Internet using a sophisticated information flow monitoring system. InfoWatch searches to find protected content distributed throughout the Internet. After the information is collected, the content is filtered to provide the content owners with an accurate profile of filesharing activities.

InfoGuard is the data sentinel. It works within the network infrastructure (typically implemented within a router or a switch, although other implementations are possible, such as server-based, as well as all-hardware, or all-software, or all-firmware, or a mix thereof) to secure intellectual property. InfoGuard can send e-mail alerts to copyright violators, embed verbal and visual advertisements into the inappropriately distributed content, inject noise into the pirated content, or stop the flow of the content all together. InfoGuard may be thought of a type of intelligent firewall, an intelligent router, or an intelligent switch, in that it blocks some content files from being transferred, while permitting others to pass, or to pass with alterations/edits. InfoGuard can identify the type of file and identity of the file by creating a tag for it, and comparing the tag to a database of tags (InfoMart database).

Additionally, the following two appendices are incorporated by reference as if fully recited herein: APPENDIX 1, entitled White Paper: InfoSeer Audio Scan Techniques, and APPENDIX 2, entitled InfoSeer Inc. Response to RIAA/IFPI Request for Information on Audio Fingerprinting Technologies, July 2001.

When residing on a local machine, the system monitors the file system for any new file system events. For example, these events could be a file being created, deleted, modified or renamed. When one of these file system events occurs, the system looks at the affected file to determine if it is copyrighted or private media. This may be determined by several means. For example, one way would be to examine the media for a watermark of some form. When a file is found that is copyrighted, it is added to a local InfoMart-type database of information that needs to be protected. (The local InfoMart can be updated over a corporate network periodically.) Once a file is in the local InfoMart database, the movement of the file system is tracked. This ensures that even if the original is not the file being distributed, the copyright is still being protected.

The system also monitors all TCP/IP and UDP/IP connections that each application opens for use. These connections are monitored to see if one of the files being protected is about to be distributed. If the data is not protected, then the data is allowed to proceed to its destination. If the data is being protected, then it is blocked from continuing to its destination. In this way, the privacy or copyright of the content is protected. (Note that the invention is not limited to the TCP/IP and UDP/IP protocols, but is applicable to any number of communications protocols.)

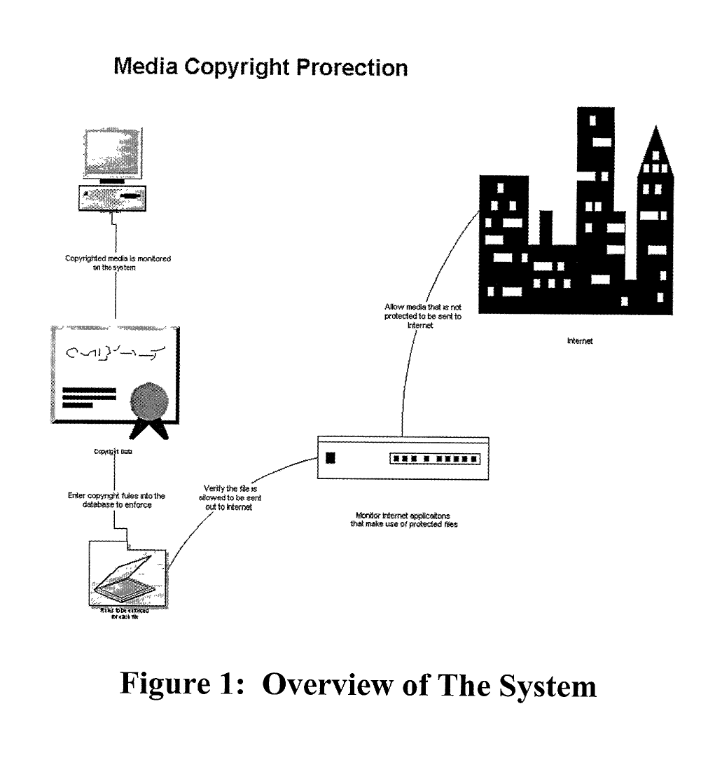

An overview of the invention on a local system is shown in FIG. 1, which illustrates a personal computer and the actions of monitoring the local system and monitoring network applications for dispersion or distribution of privately owned or copyrighted material. In the preferred embodiment, the system monitors file system events that occur and decides which action should be taken based on the event.

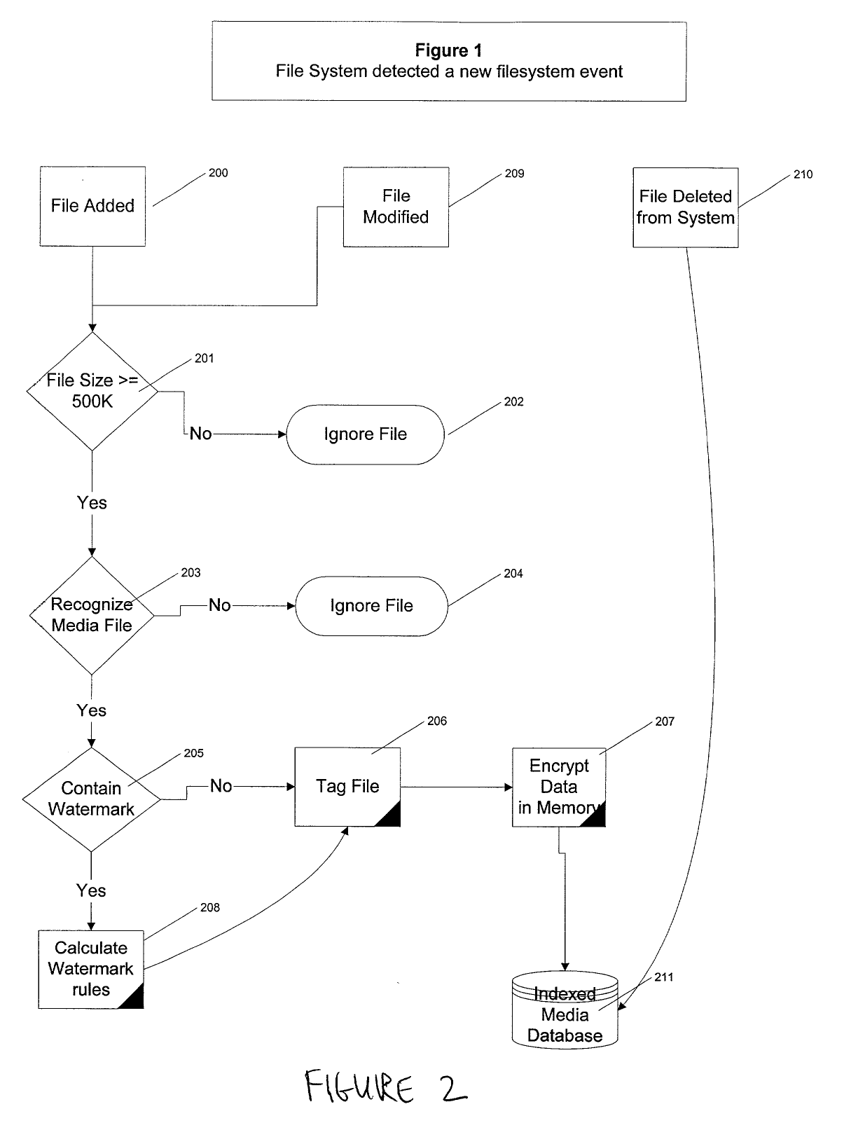

FIG. 2 is flow chart representing an example of an algorithm utilized to monitor the file system. Whenever a copyrighted file is placed on the system it triggers an “add” file system event (200). At that point, the system scans the file and creates a tag associated with that file. It also checks to see if a watermark is present because a watermark can be used to enhance copyright protection. This information is stored in the local InfoMart database. Whenever a protected file is modified or renamed, that event is tracked as well. If a file is deleted, then it is removed from the system.

The system does not track any files that are not of a type it is interested in (i.e., entertainment media, books, movies, photographs, images, technical documents, blueprints, medical/financial data files, etc.). This requires the system to eliminate unnecessary files from its consideration to make the process as fast as possible. Part of this is done by looking at the size of the file and eliminating files below a certain size. If they are above that size then they are scrutinized further. The next step is recognizing the file format, regardless of the extension. This allows files to be tracked even if the extension is changed in an attempt to disguise the file. Each file has a “header” that identifies the format of the file but not necessarily the content. An example is the header at the beginning of an audio file. Every audio file starts off with “0A 02 08 0C 0F”. So if the system encountered a file beginning with the header “0A 02 08 0C 0F” the system would recognize the file as an audio file. Movie files have their own header. Accordingly, in the preferred embodiment, the system will have the capability to track all entertainment media file types, and any other types it is instructed to recognize.

At this point the system has recognized that this particular file needs to be monitored, so it starts the process of tagging the file. This may be done using several aspects. One aspect is the use of a watermark, if one is present. The manufacturer likely placed the watermark there, and the watermark is preferably SDMI compliant. The watermark also gives some guidance as to how the file should be used. When the watermark is extracted, the rules for that file can be established. Those rules are entered into the database in association with this file and every file derived from the original.

Another aspect is the use of an algorithm that processes the file and generates a unique tag. The tag is used as determine what actions can be performed on the file, such as sending it out over a computer network, such as the Internet, or not to allow that action. The tag is used to look up a set of rules corresponding to the tag in the InfoMart database. The InfoMart database returns the rules for the protected content, and then the rules may be also stored in the same InfoMart database as the rules for the watermark (alternatively, a separate database may be used).

Before the data (tag) about the file is stored in the InfoMart database, it can be encrypted to verify that the database cannot be tampered with in order to defeat the system. The encryption is flexible in order to allow for changes or updates if the encryption is compromised. Note that each local machine can have its own encryption mechanism, so that if a particular desktop is hacked, only that desktop, and no other, is compromised. A network server would maintain a set of translators for translating tags from each local machine into tags stored in the master InfoMart database maintained on the network server.

As may be seen from FIG. 2, which shows a diagram of the file system monitor part of the system, when a file is added to the system, the system registers a “file added” event (200). The system then decides if the file is of a type that it needs to consider. For example, (201) such a decision may be based on file size. If the file is smaller than a certain size (of if the file does not meet some other predetermined criteria), subsequent operations with that file are ignored (202). If the file fits the criteria, the system then attempts to recognize if it is a media file, or some other type of file that it knows how to recognize and watch for (203). If the file is not of the type that it knows to recognize, then it will ignore subsequent operations relating to the file (204). If the file is of a type that the system recognizes, the system will check if it contains a watermark (205). If there is no watermark, the system will generate a tag corresponding to the file (206). The tag will be stored in an encrypted form in memory or on a hard drive. If the file does have a watermark, the system will determine what rules apply to the file (208).

Note also that in the case of exchange of encrypted files, the InfoTag can be generated for both the unencrypted file and the encrypted file, or, alternatively, only for the encrypted file. Thus, it is not necessary for the tag generation mechanism to know what the type of file it is dealing with, if it is encrypted, since it is comparing tags, not files themselves. Note that it may be possible to unencrypt the file first, to generate a tag, and compare tags for unencrypted files. Alternatively, as noted above, it is possible to compare tags for encrypted files.

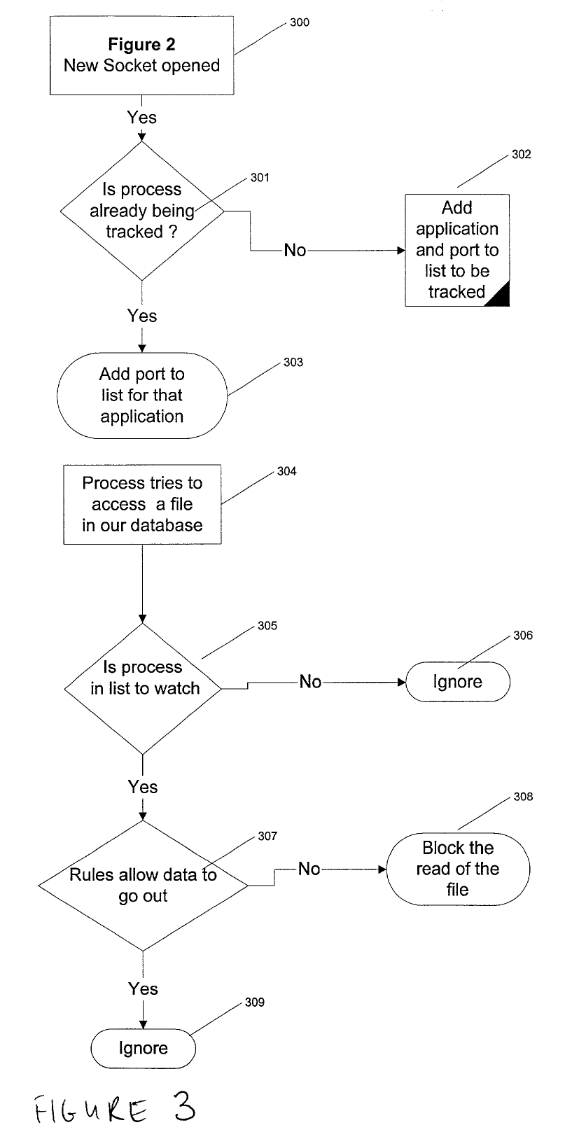

FIG. 3 is a flow chart representing an example of an algorithm utilized to monitor network socket connections. In the preferred embodiment, the second part of the system deals with the monitoring of the TCP/IP and UDP/IP socket connections to the Internet. Every one of these sockets is a possible conduit to the Internet for protected data, so they must all be watched to verify that nothing that is protected is being sent out to the Internet. The system performs that action by doing the following steps:

As may be seen in FIG. 3, the system looks at the TCP/IP stack to see if a new socket/port is opened (301). If it is opened, then the system looks at which application opened this port (301). If the application is not being monitored, then it is added to list of applications to watch for copyright violations (302). If a socket/port is closed, then that application is removed from the list if that was the only socket/port associated with it. If an application has more than one socket/port, then it is not be removed from the list until all the socket/ports are closed.

The system looks at which applications are using the protected files. If an application, that has a socket/port connection to a computer network, such as the Internet, attempts to access the protected files, the system accesses the database that contains the rules associated with that file. If the rules don't allow that file to be sent out over the computer network, the system monitors the socket/ports that the application has opened. If the contents of the data being sent to the computer network match those of the file that was accessed, then transaction is stopped, thus protecting the copyright.

FIG. 3 shows a diagram of a process of monitoring of socket connections. As may be seen from FIG. 3, the system recognizes that a new socket has been opened (300). If the process that opened the socket is already being tracked (301), the port is added to a list for that application (303). Otherwise, the application and the port are added to a list that needs to be tracked (302). A triggering event occurs when a process tries to access a file in a database, with the file being one of the ones that are being monitored (304). If the process is on a list of processes that needs to be watched (305), then a decision needs to be made about whether the data is allowed to go out over the socket or not (307). If the process is not on the list of processes that needs to be watched, then the transaction is ignored (306). If the rules allow the file or the data to go out over the socket, then the system ignores the transaction, and the file is transmitted over the socket (309). Otherwise, the file transfer is blocked (308).

Another embodiment of the present invention works in conjunction with a routing infrastructure of a network. Any data coming from certain IP addresses and ports is redirected to a monitoring system (InfoGuard) via a routing mechanism. A load balancing system determines which privacy control system to send the incoming network connection to. Once the network connection is received by the monitoring system (InfoGuard), it can determine if intellectual property is being passed through the router. If intellectual property is detected, the InfoGuard monitoring system takes the action determined (usually in advance) by the owner(s) of the intellectual property.

Which IP Addresses and Ports should be routed to the InfoGuard system through a router and a firewall are determined by the InfoWatch system, and distributed throughout the Internet infrastructure (akin to DNS database) as the InfoMart database. Routing tables and firewall settings are regularly updated to monitor only those IP addresses and ports of certain machines. This setup allows to only look at packets of data coming from and going to certain machines. The benefits of only looking at data coming from and going to certain machines are that the performance of the network is not hindered, and a larger set of data does not have to be examined. The InfoGuard system then forwards data to the load balancing system which serves multiple purposes.

The InfoGuard monitoring system monitors the data flow path from the Internet to the user, and thus that allows the InfoGuard monitoring system to inspect data packets for suspected intellectual property, and take the appropriate action based on instructions of the owner of the intellectual property.

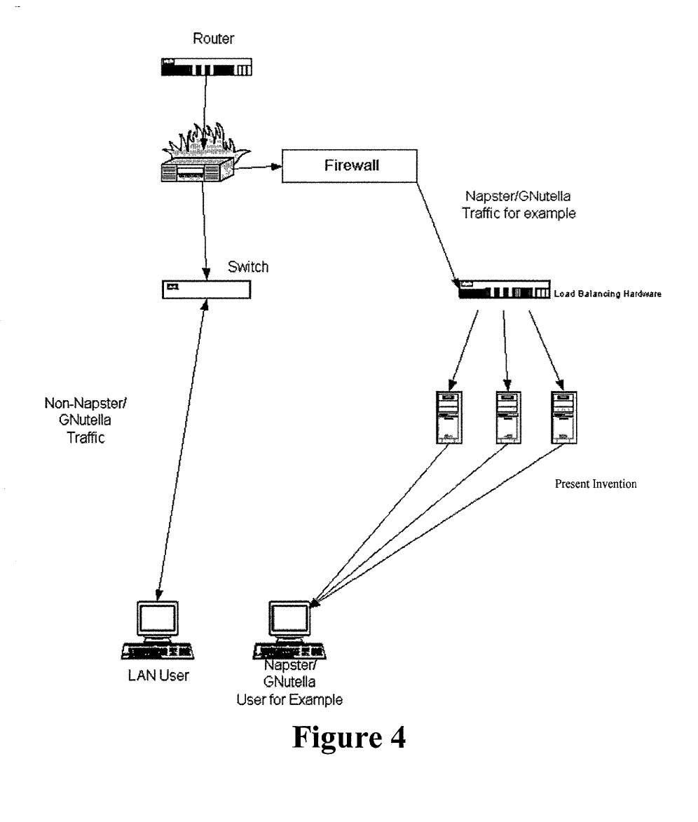

FIG. 4 is a representation of the physical nature of the InfoGuard system. The load balancing feature of the router-based system is beneficial and serves many purposes. The load balancing system allows for scalability, redundancy and performance. Scalability comes from the fact that one can easily add another InfoGuard machine if an increase in usage is seen, as more people are attempting to transmit intellectual property without the permission. Redundancy stems from load balancing, because if one machine goes down due to a hardware or software failure, the system will still function. The performance benefit comes from the fact that one can process multiple requests in parallel as opposed to sequentially processing the requests. This also gives greater speed and provides the ability to upgrade machines as needed. Note that load balancing is not required for the InfoGuard system to work, but it greatly enhances the overall system. See FIG. 4 for an overview of the system architecture on a network.

The router portion of the InfoGuard system does the processing of network and Internet connections and packets being sent through that connection. The network/Internet connections are routed to a detection and control system, and that system in turn establishes a connection to the destination machine and an information database. This connection establishes the following flow of data:

Network/Internet→Router→Firewall→Load Balancing→InfoGuard Client and Routing System→Destination

In another embodiment, the data flow may look as follows:

Network/Internet→InfoGuard Client Routing System→Firewall →Destination

Note that a firewall is not actually required, although most practical implementations will likely have one.

The InfoGuard monitoring system buffers packets of data and runs a tagging algorithm from an information identification module on the buffered data. That tag is then compared to the InfoMart database to see if a match is located. If there is a match located, the rules that are associated with that tag are returned. Those rules dictate what action the InfoGuard system takes, and depend on what action the owner of the intellectual property wants to take. Some possible actions could be: log the transaction, stop the transaction, add an advertisement into the file (e.g., “This song is the property of . . . ”, or a visual advertisement for a movie), sprinkle the file with dead air, distort the music file or video file to the point where the user would not want to listen to it or watch it, or a combination of them.

Dead air can be injected into the file by removing the meaningful data and then replacing that with useless data. If dead air is injected into the file, the user has the perception that they did receive the entire file even though they in fact didn't. This is a useful deterrent, because in most cases downloads take quite some time (especially at slower modem speeds, such as 56K baud), and if the user keeps getting a useless file, they are less inclined to steal intellectual property.

In order for the system of the present invention to do its work, it must communicate with the InfoMart database. InfoMart is the database that stores all the tags for the files that are being monitored. All the IP Addresses and port numbers of machines that are offering intellectual property via the Internet is provided in a database called InfoWatch. The IP addresses and port numbers are constantly being updated as new machines offer up intellectual property, and other machines stop offering up intellectual property. The connection to the InfoMart database is through ODBC connections to allow maximum flexibility of database configurations. The current configuration is done using the SQL Server database engine.

The InfoGuard system also performs a search of the InfoWatch database for new IP addresses and port numbers, and in turn updates the router/firewall based upon the results of that search. This step redirects any data coming from a certain IP address and port to the InfoGuard system for processing. This programmatic updating makes the InfoGuard monitoring system efficient as well as more accurate. It is also possible, but usually not practical, to have a human in the loop to update the router/firewall.

As noted above, the InfoGuard system relies on (content owner-provided) rules for deciding what to do with a particular file. The decision on which rule to apply is based on the InfoTag. The rules may be looked up in a database, or, for speed, may be hardwired into the router or switch.

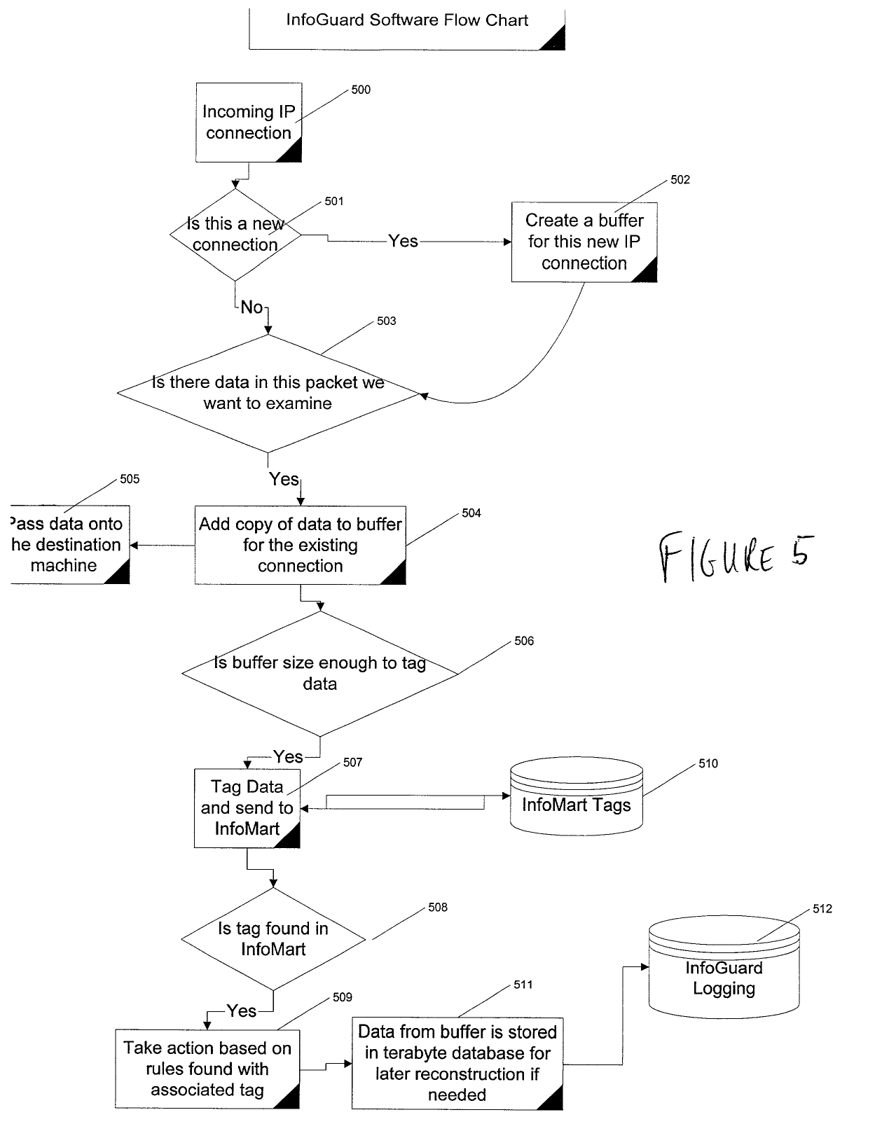

As may be further seen from FIG. 5, the InfoGuard System identifies that there is an incoming IP connection (500). The system then determines if this is a new connection (501). If it is a new connection, a new buffer for the new IP connection is created (502). If it is not a new connection, the InfoGuard system then asks if there is data in this packet that it needs to examine (503). Similarly, once a new buffer for the new IP connection is created (502), InfoGuard will determine if there is a packet that needs to be examined (503). The InfoGuard system will then add a copy of the data to the buffer for the existing connection (504). The InfoGuard system will then pass the data on to the destination machine (505). The InfoGuard system then determines if the buffer size is sufficient to tag the data (506). If yes, the data is tagged, and the tag is sent to the InfoMart database 510 (step 507). The InfoGuard system then tries to match the newly created tag to an existing tag and the InfoMart database 510 (step 508). If there is a match action will be taken based on rules associated with the particular tag, the rules being predefined by the owner of the proprietary content (509). The data from the buffer may be stored in a terabyte database for later reconstruction if necessary ( 511). InfoGuard logging 512 keeps track of access information and whether the transaction was allowed to proceed, or was blocked.

Additionally, the buffer can be useful when the nature of the file is such that even transmitting a portion of a file or document should not be permitted. For example, in the case of a sensitive document, even a portion of it should not be transmitted, and a buffer may be needed. On the other hand, receiving half a movie is not terribly useful, so a buffer might not be used in that application.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An intelligent router comprising:
means for analyzing content being transferred through it; and
means for identifying if the content is proprietary.

2. The intelligent router of claim 1, further including means for blocking the content from being transferred across the router.

3. The intelligent router of claim 1, further including means for modifying the content before transferring it downstream.

4. The intelligent router of claim 3, wherein the means for modifying the content includes means for adding dead air to a music file.

5. The intelligent router of claim 3, wherein the means for modifying the content includes means for adding an advertisement to a movie file.

6. The intelligent router of claim 3, wherein the means for modifying the content includes means for adding noise.

7. The intelligent router of claim 3, wherein the means for modifying the content includes means for cutting off a portion of the content.

8. The intelligent router of claim 3, wherein the means for modifying the content includes means for corrupting the content.

9. The intelligent router of claim 3, wherein the means for analyzing the content includes means for generating a tag corresponding to the content.

10. The intelligent router of claim 9, wherein the tag includes spectral information corresponding to the content.

11. The intelligent router of claim 9, wherein the tag includes an IP address corresponding to the content.

12. The intelligent router of claim 9, wherein the tag includes an identifier of what action to take with regard to the content.

13. The intelligent router of claim 9, wherein the tag identifies an owner of the content.

14. The intelligent router of claim 9, wherein the means for generating a tag further includes means for comparing the tag to other tags.

15. The intelligent router of claim 14, wherein the means for comparing the tag to other tags compares the tag to the other tags in a database of tags.

16. The intelligent router of claim 1, wherein the means for analyzing and the means for identifying are embodied in software.

17. The intelligent router of claim 1, wherein the means for analyzing and the means for identifying are embodied in hardware.

18. The intelligent router of claim 1, wherein the means for analyzing and the means for identifying are embodied in firmware.

19. The intelligent router of claim 1, wherein the content includes a music file.

20. The intelligent router of claim 1, wherein the content includes a movie file.

21. The intelligent router of claim 1, wherein the content includes at least a portion of a book.

22. The intelligent router of claim 1, wherein the content includes an image.

23. An intelligent switch comprising:
means for analyzing content being transferred through it; and
means for identifying if the content is proprietary.

24. The intelligent switch of claim 23, further including means for blocking the content from being transferred across the switch.

25. The intelligent switch of claim 23, further including means for modifying the content before transferring it downstream.

26. The intelligent switch of claim 25, wherein the means for modifying the content includes means for adding dead air to a music file.

27. The intelligent switch of claim 25, wherein the means for analyzing the content includes means for generating a tag corresponding to the content.

28. The intelligent switch of claim 27, wherein the tag includes spectral information corresponding to the content.

29. The intelligent switch of claim 27, wherein the tag includes an IP address corresponding to the content.

30. The intelligent switch of claim 27, wherein the tag includes an identifier of what action to take with regard to the content.

31. The intelligent switch of claim 27, wherein the means for generating a tag further includes means for comparing the tag to other tags.

32. The intelligent switch of claim 31, wherein the means for comparing the tag to other tags compares the tag to the other tags in a database of tags.

33. The intelligent switch of claim 23, wherein the means for analyzing and the means for identifying are embodied in software.

34. The intelligent switch of claim 23, wherein the means for analyzing and the means for identifying are embodied in hardware.

35. The intelligent switch of claim 23, wherein the content includes a music file.

36. The intelligent switch of claim 23, wherein the content includes a movie file.

37. A method for routing content across a network router comprising the steps of:
analyzing the content being transferred through it; and
identifying if the content is proprietary.

38. The method of claim 37, further including the step of blocking the content from being transferred across the router.

39. The method of claim 37, further including the step of modifying the content before transferring it downstream.

40. The method of claim 39, wherein the step of modifying the content includes step of adding dead air to a music file.

41. The method of claim 39, wherein the step of modifying the content includes the step of adding an advertisement to a movie file.

42. The method of claim 39, wherein the step of modifying the content includes the step of adding noise.

43. The method of claim 39, wherein the step of modifying the content includes the step of cutting off a portion of the content.

44. The method of claim 39, wherein the step of modifying the content includes means for corrupting it.

45. The method of claim 37, wherein the step of analyzing the content includes step of generating a tag corresponding to the content.

46. The method of claim 45, wherein the tag includes spectral information corresponding to the content.

47. The method of claim 45, wherein the tag includes an IP address corresponding to the content.

48. The method of claim 45, wherein the tag includes an identifier of what action to take with regard to the content.

49. The method of claim 45 wherein the tag identifies an owner of the content.

50. The method of claim 45, wherein the step of generating a tag further includes the step of comparing the tag to other tags.

51. The method of claim 50, wherein the step of comparing the tag to other tags compares the tag to the other tags in a database of tags.

52. The method of claim 37, wherein the step of analyzing and the step of identifying are embodied in software.

53. The method of claim 37, wherein the step of analyzing and the step of identifying are embodied in hardware.

54. The method of claim 37, wherein the step of analyzing and the step of identifying are embodied in firmware.

55. The method of claim 37, wherein the content includes a music file.

56. The method of claim 37, wherein the content includes a movie file.

57. The method of claim 37, wherein the content includes at least a portion of a book.

58. The method of claim 37, wherein the content includes an image.

59. A method for routing content across a network switch comprising the steps of:
analyzing content being transferred through it; and
identifying if the content is proprietary.

60. The method of claim 59, further including the step of blocking the content from being transferred across the switch.

61. The method of claim 59, further including the step of modifying the content before transferring it downstream.

62. The method of claim 61, wherein the step of analyzing the content includes the step of generating a tag corresponding to the content.

63. The method of claim 62, wherein the tag includes spectral information corresponding to the content.

64. The method of claim 62, wherein the tag includes an IP address corresponding to the content.

65. A computer program product for intelligently routing content in a network environment comprising:
a computer usable medium having computer readable program code means embodied in the computer usable medium for causing an application program to execute on a computer system, the computer readable program code means comprising:
computer readable program code means for analyzing content being transferred through it; and
computer readable program code means for identifying if the content is proprietary.
